(19) United States
(12) Patent Application Publication
(10) Pub. No.: US 2018/0324439 A1
(43) Pub. Date: Nov. 8, 2018

(54) METHOD AND APPARATUS FOR ADAPTIVE VIDEO ENCODING

(71) Applicant: MEDIATEK INC., Hsin-Chu (TW)

(72) Inventors: Tung-Hsing Wu, Hsin-Chu (TW); Kuan-Hung Chou, New Taipei City (TW); Han-Liang Chou, Hsin-Chu (TW); Chien-Chang Wang, Hsinchu County (TW)

(21) Appl. No.: 15/973,503

(22) Filed: May 7, 2018

Related U.S. Application Data
(60) Provisional application No. 62/502,831, filed on May 8, 2017.

(51) Int. Cl. H04N 19/146; H04N 19/126; H04N 19/132

(52) U.S. Cl. CPC H04N 19/146; H04N 19/132; H04N 19/126

(57) ABSTRACT

An adaptive video encoding method includes: encoding, by an encoding circuit, a current frame to generate a current encoded frame; and after the current frame is encoded, obtaining quantization parameter information of at least one encoded frame, wherein the at least one encoded frame includes the current encoded frame, and referring to the quantization parameter information to adaptively adjust a frame rate of at least one next frame to be actually encoded by the encoding circuit.

### CROSS REFERENCE TO RELATED APPLICATIONS

This application claims the benefit of U.S. provisional application No. 62/502,831, filed on May 8, 2017 and incorporated herein by reference.

### BACKGROUND

The disclosed embodiments of the present invention relate to video encoding, and more particularly, to a method and apparatus for adaptive video encoding.

The conventional video coding standards generally adopt a block based coding technique to exploit spatial and temporal redundancy. For example, the basic approach is to divide the whole source frame into a plurality of blocks, perform prediction on each block, transform residues of each block using discrete cosine transform, and perform quantization and entropy encoding. Besides, a reconstructed frame is generated in a coding loop to provide reference pixel data used for coding following blocks under inter prediction. For certain video coding standards, in-loop filter(s) may be used for enhancing the image quality of the reconstructed frame.

For certain real-time communication application such as video over LTE (ViLTE), the available channel bandwidth may vary due to channel variation. If video frames are encoded at a fixed frame rate by a transmitter end, it is possible that large quantization parameters are needed by encoding of blocks in video frames for allowing the resulting encoded video frames generated at the fixed frame rate to be successfully transmitted over a channel with a small channel bandwidth. After the encoded video frames are decoded at a receiver end, the image quality of the decoded video frames is poor due to artifacts introduced by quantization that uses large quantization parameters. Moreover, if the encoding setting of a video frame is not properly set, the coding efficiency of the video frame may be poor.

Thus, there is a need for an adaptive video encoding scheme which is capable of improving the image quality of the decoded video frames at a decoder end and/or the coding efficiency of the video frames at an encoder end by adaptively adjusting the video encoding operation at the encoder end.

### SUMMARY

In accordance with exemplary embodiments of the present invention, a method and apparatus for adaptive video encoding are proposed to solve the above-mentioned problem.

According to a first aspect of the present invention, an exemplary adaptive video encoding method is disclosed. The exemplary adaptive video encoding method includes: encoding, by an encoding circuit, a current frame to generate a current encoded frame; and after the current frame is encoded, obtaining quantization parameter information of at least one encoded frame, wherein said at least one encoded frame comprises the current encoded frame, and referring to the quantization parameter information to adaptively adjust a frame rate of at least one next frame to be actually encoded by the encoding circuit.

According to a second aspect of the present invention, an exemplary adaptive video encoding method is disclosed. The exemplary adaptive video encoding method includes: encoding, by an encoding circuit, a current frame to generate a current encoded frame; and after the current frame is encoded, setting re-encode indication according to at least encoding-related information of the current frame, and referring to the re-encode indication for adaptively re-encoding, by the encoding circuit, the current frame to update the current encoded frame.

According to a third aspect of the present invention, an exemplary video encoder for adaptive video encoding is disclosed. The exemplary video encoder includes an encoding circuit and a control circuit. The encoding circuit is arranged to encode a current frame to generate a current encoded frame. After the current frame is encoded, the control circuit is arranged to obtain quantization parameter information of at least one encoded frame, wherein said at least one encoded frame comprises the current encoded frame; and refer to the quantization parameter information to adaptively adjust a frame rate of at least one next frame to be actually encoded by the encoding circuit.

According to a fourth aspect of the present invention, an exemplary video encoder for adaptive video encoding is disclosed. The exemplary video encoder includes an encoding circuit and a control circuit. The encoding circuit is arranged to encode a current frame to generate a current encoded frame. After the current frame is encoded, the control circuit is arranged to set re-encode indication according to at least encoding-related information of the current frame, and the encoding circuit is further arranged to refer to the re-encode indication for adaptively re-encoding the current frame to update the current encoded frame.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a first video encoder for adaptive video encoding according to an embodiment of the present invention.

FIG. 2 is a flowchart illustrating a method of setting a next drop-frame level according to an embodiment of the present invention.

FIG. 3 is a continued flowchart of the method of setting the next drop-frame level.

FIG. 4 is a diagram illustrating a second video encoder for adaptive video encoding according to an embodiment of the present invention.

FIG. 5 is a flowchart illustrating a method of setting a next frame-rate level according to an embodiment of the present invention.

FIG. 6 is a continued flowchart of the method of setting the next frame-rate level.

FIG. 7 is a flowchart illustrating a first adaptive re-encoding policy that depends on an adaptive frame-rate encoding policy according to an embodiment of the present invention.

FIG. 8 is a flowchart illustrating a second adaptive re-encoding policy that depends on an adaptive frame-rate encoding policy according to an embodiment of the present invention.

FIG. 9 is a flowchart illustrating a third adaptive re-encoding policy that depends on an adaptive frame-rate encoding policy according to an embodiment of the present invention.

FIG. 10 is a flowchart illustrating a fourth adaptive re-encoding policy that depends on an adaptive frame-rate encoding policy according to an embodiment of the present invention.

FIG. 11 is a diagram illustrating a third video encoder for adaptive video encoding according to an embodiment of the present invention.

FIG. 12 is a flowchart illustrating a first adaptive re-encoding policy that is independent of an adaptive frame-rate encoding policy according to an embodiment of the present invention.

FIG. 13 is a flowchart illustrating a second adaptive re-encoding policy that is independent of an adaptive frame-rate encoding policy according to an embodiment of the present invention.

FIG. 14 is a flowchart illustrating a third adaptive re-encoding policy that is independent of an adaptive frame-rate encoding policy according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

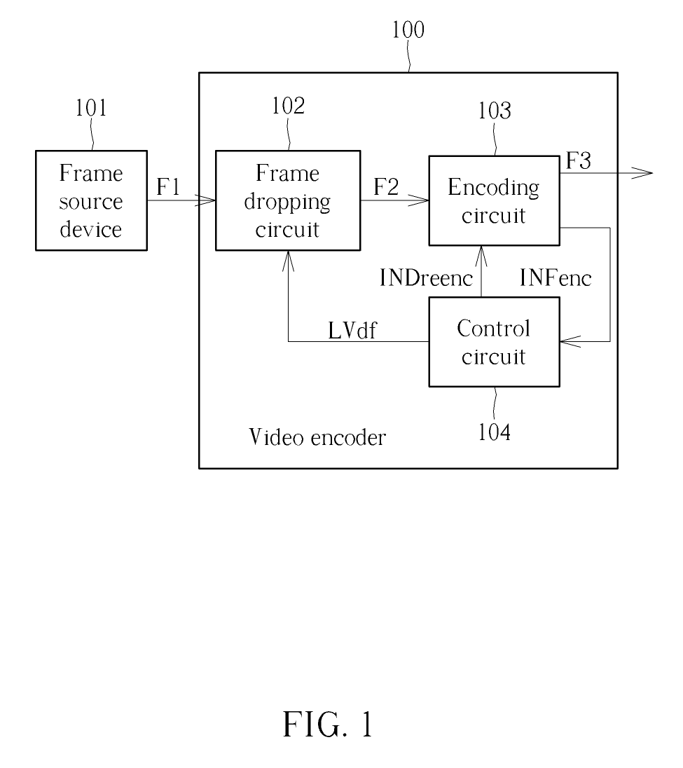

FIG. 1 is a diagram illustrating a first video encoder for adaptive video encoding according to an embodiment of the present invention. In some embodiments of the present invention, the video encoder 100 may be a part of a wireless communication apparatus such as a tablet or a mobile phone. The video encoder 100 is coupled to a frame source device 101. For example, the frame source device 101 may be an image capture device (e.g., an image sensor of a camera module) also located at the wireless communication apparatus. In this embodiment, the video encoder 100 supports adaptive video encoding, and includes a frame dropping circuit 102, an encoding circuit 103, and a control circuit 104. The frame source device 101 is arranged to generate and output successive frames (i.e., un-encoded frames) F1 to the frame dropping circuit 102. The frame dropping circuit 102 is controlled by a drop-frame level LVdf to selectively drop frames among the successive frames F1 received by the video encoder 100, and is arranged to output frames (i.e., un-encoded frames) F2 to the encoding circuit 103. The encoding circuit 103 is arranged to encode the frames F2 to generate and output corresponding encoded frames F3, respectively.

The control circuit 104 is implemented to control an adaptive video encoding function of the video encoder 100. In this embodiment, the control circuit 104 gets encoding-related information INFenc of frames encoded by the encoding circuit 103, and adaptively adjusts the drop-frame level LVdf according to the encoding-related information INFenc. For example, the control circuit 104 obtains quantization parameter information QPenc of at least one encoded frame according to the encoding-related information INFenc.

In this embodiment, after the encoding circuit 103 encodes a current frame (i.e., a current un-encoded frame) to generate a current encoded frame, the control circuit 104 obtains the quantization parameter information QPenc of at least one encoded frame, wherein the at least one encoded frame includes the current encoded frame. For example, the control circuit 104 determines the quantization parameter information QPenc by applying an arithmetic operation to quantization parameters (QPs) derived from quantization parameters assigned to blocks that are encoded in the at least one encoded frame, wherein the arithmetic operation may be used to obtain an average value of QPs, a weighted sum value of average QPs, a minimum value of QPs, or a maximum value of QPs.

In a first exemplary design, the control circuit 104 may obtain the quantization parameter information QPenc of the current encoded frame. For example, the quantization parameter information QPenc is the average of quantization parameters assigned to blocks that are encoded in the current encoded frame. For another example, the quantization parameter information QPenc is the maximum value among quantization parameters assigned to blocks that are encoded in the current encoded frame.

In a second exemplary design, the control circuit 104 may obtain the quantization parameter information QPenc of the current encoded frame and one or more previous encoded frames. For example, the quantization parameter information QPenc is the weighted sum of the average QP of the current encoded frame and average QP(s) of previous encoded frame(s). The computation of the quantization parameter information QPenc may be expressed using the following equation: QPenc=QP_{frm0}×½+QP_{frm1}×¼+QP_{frm2}×⅛+ . . . , where QP_{frm0} is the average QP of encoded frame 0 (i.e., current encoded frame), QP_{frm1} is the average QP of encoded frame 1 (i.e., previous encoded frame) that is generated immediately before encoded frame 0, and QP_{frm2} is the average QP of encoded frame 2 (i.e., previous encoded frame) that is generated immediately before encoded frame 1. Hence, when a next frame becomes a current frame and is encoded to generate a current encoded frame with the average QP denoted by QP_{frm0}, the quantization parameter information QPenc may be updated by using the equation: QPenc=QP_{frm0}×½+QPenc×½. For another example, the quantization parameter information QPenc is the maximum value among quantization parameters assigned to blocks that are encoded in the current encoded frame and the previous encoded frame(s).

When the quantization parameter information QPenc is obtained after the current frame is encoded, the control circuit 104 refers to the quantization parameter information QPenc to adaptively adjust/control a frame rate of at least one next frame to be actually encoded by the encoding circuit 103. In this embodiment, the control circuit 104 determines a next drop-frame level LVdf according to a current drop-frame level LVdf and the quantization parameter information QPenc, and the frame dropping circuit 102 adaptively adjusts/controls the frame rate of next frame(s) by selectively dropping at least one frame received from the frame source device 101 according to the next drop-frame level LVdf set by the control circuit 104.

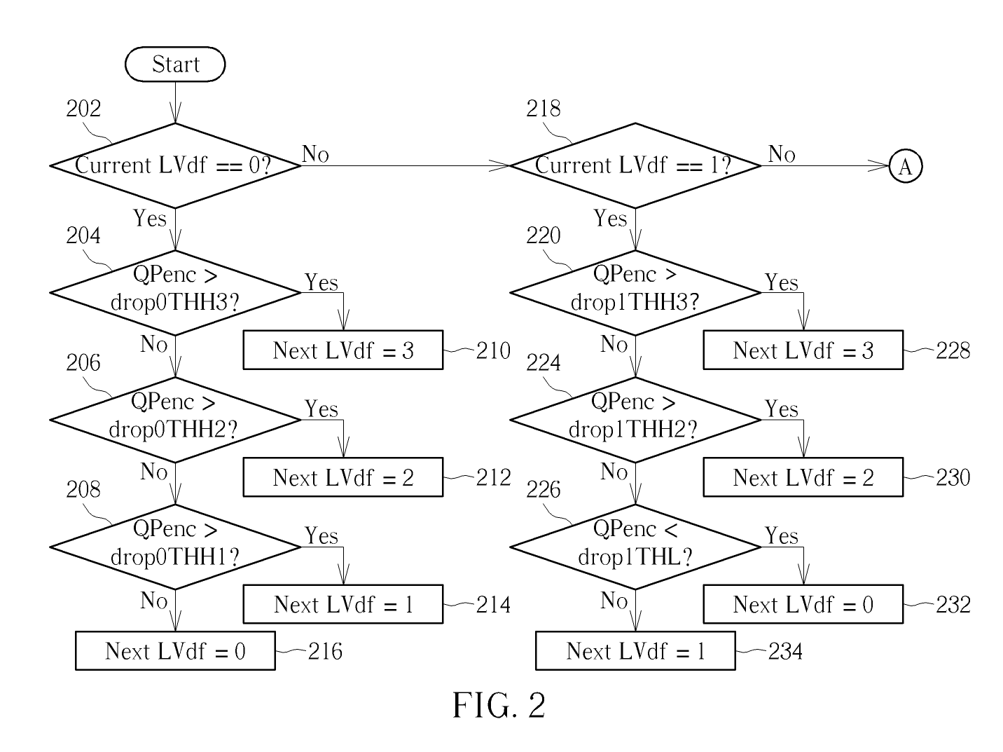

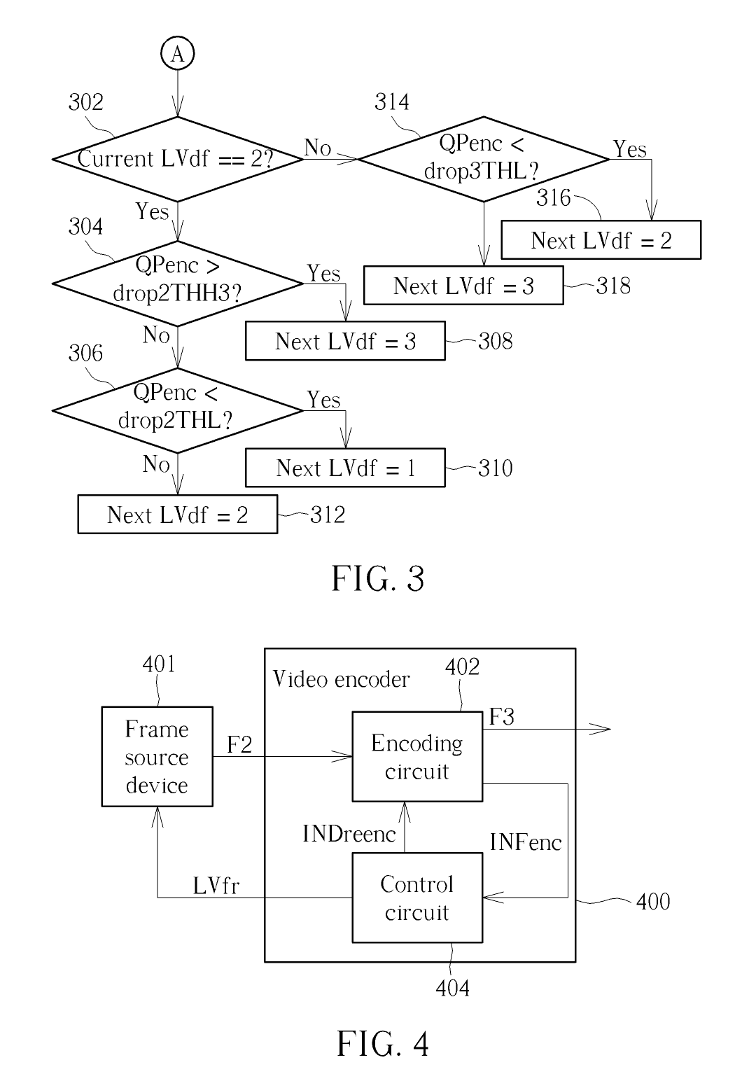

FIG. 2 is a flowchart illustrating a method of setting the next drop-frame level LVdf according to an embodiment of the present invention. FIG. 3 is a continued flowchart of the method of setting the next drop-frame level LVdf. Provided that the result is substantially the same, the steps are not required to be executed in the exact order shown in FIG. 2 and FIG. 3. Step 202 is used to check if the current drop-frame level LVdf is drop-frame level 0. Step 218 is used to check if the current drop-frame level LVdf is drop-frame level 1. Step 302 is used to check if the current drop-frame level LVdf is drop-frame level 2. Steps 204, 206, 208, 210, 212, 214, and 216 are associated with setting of the next drop-frame level under a condition that the current drop-frame level is 0. Steps 220, 224, 226, 228, 230, 232, and 234 are associated with setting of the next drop-frame level LVdf under a condition that the current drop-frame level is 1. Steps 304, 306, 308, 310, and 312 are associated with setting of the next drop-frame level LVdf under a condition that the current drop-frame level is 2. Steps 316 and 318 are associated with setting of the next drop-frame level LVdf under a condition that the current drop-frame level is 3.

Regarding the flow shown in FIG. 2 and FIG. 3, drop0THH3 is a threshold for entering the drop-frame level 3 when the current drop-frame level is 0, drop0THH2 is a threshold for entering the drop-frame level 2 when the current drop-frame level is 0, drop0THH1 is a threshold for entering the drop-frame level 1 when the current drop-frame level is 0, drop1THH3 is a threshold for entering the drop-frame level 3 when the current drop-frame level is 1, drop1THH2 is a threshold for entering the drop-frame level 2 when the current drop-frame level is 1, drop2THH3 is a threshold for entering the drop-frame level 3 when the current drop-frame level is 2, drop1THL is a threshold for entering the drop-frame level 0 when the current drop-frame level is 1, drop2THL is a threshold for entering the drop-frame level 10 when the current drop-frame level is 2, and drop3THL is a threshold for entering the drop-frame level 2 when the current drop-frame level is 3.

The frame rate is determined/controlled by the drop-frame level LVdf. In this embodiment, the drop-frame level 0 (i.e., LVdf=0) means no dropping of un-encoded frames received from the frame source device 101, such that the new frame rate is equal to the maximum frame rate FR_MAX; the drop-frame level 1 (i.e., LVdf=1) means dropping 1 un-encoded frame among 5 consecutive un-encoded frames received from the frame source device 101, such that the new frame rate is equal to FR_MAX*(4/5); the drop-frame level 2 (i.e., LVdf=2) means dropping 1 un-encoded frame among 3 consecutive un-encoded frames received from the frame source device 101, such that the new frame rate is equal to FR_MAX*(2/3) ; and the drop-frame level 3 (i.e., LVdf=3) means dropping 1 un-encoded frame among 2 consecutive un-encoded frames received from the frame source device 101, such that the new frame rate is equal to FR_MAX*(1/2).

The following table shows a first example of the corresponding frame rates at different drop-frame levels, where the frame rate at the drop-frame level 0 is 30 fps (frames per second).

TABLE 1

| Drop-frame level | Frame rate (fps) |
|---|---|
| 0 | 30 |
| 1 | 24 |
| 2 | 20 |
| 3 | 15 |

The following table shows a second example of the corresponding frame rates at different drop-frame levels, where the frame rate at the drop-frame level 0 is 20 fps.

TABLE 2

| Drop-frame level | Frame rate (fps) |
|---|---|
| 0 | 20 |
| 1 | 16 |
| 2 | 13.3 |
| 3 | 10 |

In the embodiment shown in FIG. 1, the frame rate of next frame (s) to be actually encoded by the encoding circuit 103 is controlled through using the frame dropping circuit 102 to adaptively dropping un-encoded frames received from the frame source device 101 according to the drop-frame level LVdf set by the control circuit 104. However, this is for illustrative purposes only, and is not meant to be a limitation of the present invention. In an alternative design, the frame rate of next frame(s) to be actually encoded by the encoding circuit 103 may be controlled by assigning a frame-rate level to a frame source device which provides frames to the encoding circuit 103.

FIG. 4 is a diagram illustrating a second video encoder for adaptive video encoding according to an embodiment of the present invention. In some embodiments of the present invention, the video encoder 400 may be a part of a wireless communication apparatus such as a tablet or a mobile phone. The video encoder 400 is coupled to a frame source device 401. For example, the frame source device 401 may be an image capture device (e.g., an image sensor of a camera module) also located at the wireless communication apparatus. In this embodiment, the video encoder 400 supports adaptive video encoding, and includes an encoding circuit 402 and a control circuit 404. The frame source device 401 is arranged to generate and output successive frames (i.e., un-encoded frames) F2 to the encoding circuit 402. In this embodiment, the frame source device 401 is controlled by a frame-rate level LVfr to selectively change the frame rate of frames supplied to the encoding circuit 402. The encoding circuit 402 is arranged to encode the frames F2 to generate and output corresponding encoded frames F3, respectively.

The control circuit 404 is implemented to control an adaptive video encoding function of the video encoder 400. In this embodiment, the control circuit 404 gets encoding-related information INFenc of frames encoded by the encoding circuit 402, and adaptively adjusts/controls the frame-rate level LVfr according to the encoding-related information INFenc. For example, the control circuit 404 obtains quantization parameter information QPenc of at least one encoded frame according to the encoding-related information INFenc.

In this embodiment, after the encoding circuit 402 encodes a current frame to generate a current encoded frame, the control circuit 404 obtains the quantization parameter information QPenc of at least one encoded frame, wherein the at least one encoded frame includes the current encoded frame. For example, the control circuit 404 determines the quantization parameter information QPenc by applying an arithmetic operation to quantization parameters (QPs) derived from quantization parameters assigned to blocks that are encoded in the at least one encoded frame, wherein the arithmetic operation may be used to obtain an average value of QPs, a weighted sum value of average QPs, a minimum value of QPs, or a maximum value of QPs.

In a first exemplary design, the control circuit 404 may obtain the quantization parameter information QPenc of the current encoded frame. For example, the quantization parameter information QPenc is the average of quantization parameters assigned to blocks that are encoded in the current encoded frame. For another example, the quantization parameter information QPenc is the maximum value among quantization parameters assigned to blocks that are encoded in the current encoded frame.

In a second exemplary design, the control circuit 404 may obtain the quantization parameter information QPenc of the current encoded frame and one or more previous encoded frames. For example, the quantization parameter information QPenc is the weighted sum of the average QP of the current encoded frame and average QP(s) of previous encoded frame(s). The computation of the quantization parameter information QPenc may be expressed using the following equation: QPenc=QP_{frm0}×½+QP_{frm1}×¼+QP_{frm2}×⅛+ . . . , where QP_{frm0} is the average QP of encoded frame 0 (i.e., current encoded frame), QP_{frm1} is the average QP of encoded frame 1 (i.e., previous encoded frame) that is generated immediately before encoded frame 0, and QP_{frm2} is the average QP of encoded frame 2 (i.e., previous encoded frame) that is generated immediately before encoded frame 1. Hence, when a next frame becomes a current frame and is encoded to generate a current encoded frame with the average QP denoted by QP_{frm0}, the quantization parameter information QPenc may be updated by using the equation: QPenc=QP_{frm0}×½+QPencx×½. For another example, the quantization parameter information QPenc is the maximum value among quantization parameters assigned to blocks that are encoded in the current encoded frame and previous encoded frame(s).

When the quantization parameter information QPenc is obtained after the current frame is encoded, the control circuit 404 refers to the quantization parameter information QPenc to adaptively adjust/control a frame rate of at least one next frame to be actually encoded by the encoding circuit 402. In this embodiment, the control circuit 404 determines a next frame-rate level LVfr according to a current frame-rate level LVfr and the quantization parameter information QPenc, and instructs the frame source device 401 to provide at least one frame at a frame rate that is designated by the next frame-rate level LVfr. In this way, the frame rate of at least one next frame to be actually encoded by the encoding circuit 402 can be adaptively adjusted.

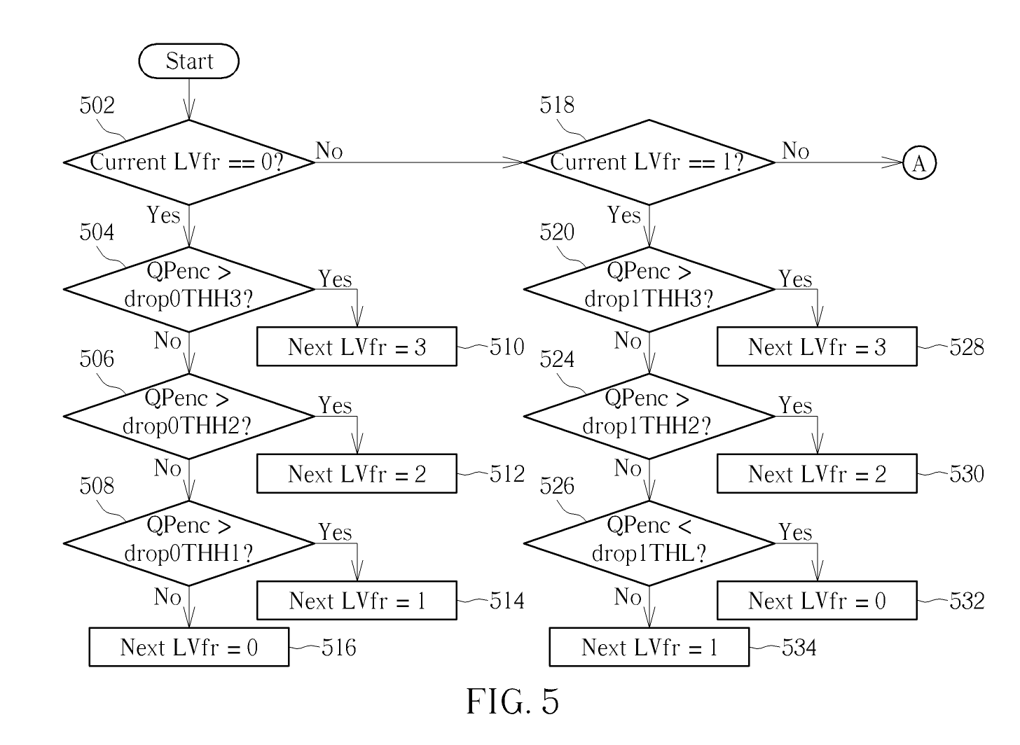

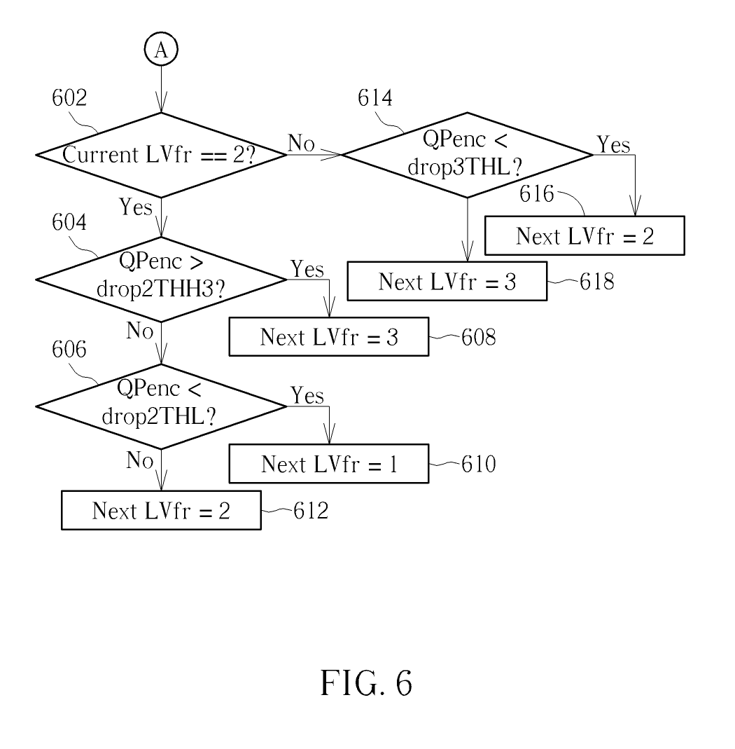

FIG. 5 is a flowchart illustrating a method of setting the next frame-rate level LVfr according to an embodiment of the present invention. FIG. 6 is a continued flowchart of the method of setting the next frame-rate level LVfr. Provided that the result is substantially the same, the steps are not required to be executed in the exact order shown in FIG. 5 and FIG. 6. Step 502 is used to check if the current frame-rate level LVfr is frame-rate level 0. Step 518 is used to check if the current frame-rate level LVfr is frame-rate level 1. Step 602 is used to check if the current frame-rate level LVfr is frame-rate level 2. Steps 504, 506, 508, 510, 512, 514, and 516 are associated with setting of the next frame-rate level under a condition that the current frame-rate level is 0. Steps 520, 524, 526, 528, 530, 532, and 534 are associated with setting of the next frame-rate level LVfr under a condition that the current frame-rate level is 1. Steps 604, 606, 608, 610, and 612 are associated with setting of the next frame-rate level LVfr under a condition that the current frame-rate level is 2. Steps 616 and 618 are associated with setting of the next frame-rate level LVfr under a condition that the current frame-rate level is 3.

Regarding the flow shown in FIG. 5 and FIG. 6, drop0THH3 is a threshold for entering the frame-rate level 3 when the current frame-rate level is 0, drop0THH2 is a threshold for entering the frame-rate level 2 when the current frame-rate level is 0, drop0THH1 is a threshold for entering the frame-rate level 1 when the current frame-rate level is 0, drop1THH3 is a threshold for entering the frame-rate level 3 when the current frame-rate level is 1, drop1THH2 is a threshold for entering the frame-rate level 2 when the current frame-rate level is 1, drop2THH3 is a threshold for entering the frame-rate level 3 when the current frame-rate level is 2, drop1THL is a threshold for entering the frame-rate level 0 when the current frame-rate level is 1, drop2THL is a threshold for entering the frame-rate level 0 when the current frame-rate level is 2, and drop3THL is a threshold for entering the frame-rate level 2 when the current frame-rate level is 3.

The frame rate is determined/controlled by the frame-rate level LVfr. In this embodiment, the frame-rate level 0 (i.e., LVfr=0) means a highest frame rate in all selectable frame-rate levels; the frame-rate level 1 (i.e., LVfr=1) means a frame rate lower than the frame-rate level 0; the frame-rate level 2 (i.e., LVfr=2) means a frame rate lower than the frame-rate level 1; and the frame-rate level 3 (i.e., LVfr=3) means a frame rate lower than the frame-rate level 2.

The following table shows a first example of the corresponding frame rates at different frame-rate levels, where the frame rate at the frame-rate level 0 is 30 fps (frames per second).

TABLE 3

| Frame-rate level | Frame rate (fps) |
|---|---|
| 0 | 30 |
| 1 | 20 |
| 2 | 15 |
| 3 | 10 |

The following table shows a second example of the corresponding frame rates at different frame-rate levels, where the frame rate at the frame-rate level 0 is 20 fps.

TABLE 4

| Frame-rate level | Frame rate (fps) |
|---|---|
| 0 | 20 |
| 1 | 15 |
| 2 | 10 |
| 3 | 7.5 |

Each of the video encoders 100 and 400 applies an adaptive frame-rate encoding policy to adaptively adjust/control a frame rate at which un-encoded frames are fed into the encoding circuit 103/402, thus resulting in an adaptively controlled frame rate at which encoded frames are generated from the encoding circuit 103/402 and transmitted via communication channel(s). When the next frame rate determined by the adaptive frame-rate encoding policy for next frame(s) to be encoded becomes lower, it implies that the quality of the current encoded frame generated from encoding the current frame with a current frame rate (which is higher than the determined next frame rate) is poor. In some embodiments of the present invention, each of the video encoders 100 and 400 may be further configured to support an adaptive re-encoding function. Hence, after the next frame rate is determined by the adaptive frame-rate encoding policy for next frame(s) to be encoded, the current frame may be adaptively re-encoded to update the current encoded frame that will be transmitted via communication channel(s).

Please refer to FIG. 1 again. The control circuit 104 may be further arranged to set re-encode indication INDreenc according to a result obtained by an adaptive frame-rate encoding policy that is performed on the basis of the encoding-related information INFenc. Suppose that the current frame with a first frame rate is received from the frame source device 101. Hence, the current frame with the first frame rate is encoded to generate the current encoded frame. As mentioned above, the adaptive frame-rate encoding policy is applied for determining a next drop-frame level LVdf according to a current drop-frame level LVdf and the quantization information QPenc, where the first frame rate is indicated by the current drop-frame level LVdf, and a second frame rate is indicated by the next drop-frame level LVdf. According to the flow shown in FIG. 2 and FIG. 3, the second frame rate may be equal to or different from (e.g., higher than or lower than) the first frame rate, depending upon a comparison result of comparing the quantization information QPenc with at least a portion (i.e., part or all) of the predetermined thresholds. When the next drop-frame level LVdf is lower than the current drop-frame level LVdf, it implies that the second frame rate (i.e., the frame rate of next frame(s) to be actually encoded by the encoding circuit 103) is lower than the first frame (i.e., the frame rate of the current frame encoded by the encoding circuit 103).

Hence, after the current frame with the first frame rate is encoded, the control circuit 104 checks if the second frame rate determined by the adaptive frame-rate encoding policy is lower than the first frame rate of the current frame. When the second frame rate determined by the adaptive frame-rate encoding policy is lower than the first frame rate, the control circuit 104 sets the re-encode indication INDreenc as true to thereby enable re-encoding of the current frame. When the second frame rate determined by the adaptive frame-rate encoding policy is not lower than the first frame rate, the control circuit 104 sets the re-encode indication INDreenc as false to thereby disable re-encoding of the current frame. To put it simply, the encoding circuit 103 re-encodes the current frame to update the current encoded frame when the re-encode indication INDreenc is true, and does not re-encode the current frame to update the current encoded frame when the re-encode indication INDreenc is false.

Please refer to FIG. 4 again. The control circuit 404 may be further arranged to set re-encode indication INDreenc according to a result obtained by an adaptive frame-rate encoding policy that is performed on the basis of the encoding-related information INFenc. Suppose that the current frame with a first frame rate is received from the frame source device 401. Hence, the current frame with the first frame rate is encoded to generate the current encoded frame. As mentioned above, the adaptive frame-rate encoding policy is applied for determining a next frame-rate level LVfr according to a current frame-rate level LVfr and the quantization information QPenc, where the first frame rate is indicated by the current frame-rate level LVfr, and a second frame rate is indicated by the next frame-rate level LVfr. According to the flow shown in FIG. 5 and FIG. 6, the second frame rate may be equal to or different from (e.g., higher than or lower than) the first frame rate, depending upon a comparison result of comparing the quantization information QPenc with at least a portion (i.e., part or all) of the predetermined thresholds. When the next frame-rate level LVfr is lower than the current frame-rate level LVfr, it implies that the second frame rate (i.e., the frame rate of next frame(s) to be actually encoded by the encoding circuit 402) is lower than the first frame (i.e., the frame rate of the current frame encoded by the encoding circuit 402).

Hence, after the current frame with the first frame rate is encoded, the control circuit 404 checks if the second frame rate determined by the adaptive frame-rate encoding policy is lower than the first frame rate of the current frame. When the second frame rate determined by the adaptive frame-rate encoding policy is lower than the first frame rate, the control circuit 404 sets the re-encode indication INDreenc as true to thereby enable re-encoding of the current frame. When the second frame rate determined by the adaptive frame-rate encoding policy is not lower than the first frame rate, the control circuit 404 sets the re-encode indication INDreenc as false to thereby disable re-encoding of the current frame. To put it simply, the encoding circuit 402 re-encodes the current frame to update the current encoded frame when the re-encode indication INDreenc is true, and does not re-encode the current frame to update the current encoded frame when the re-encode indication INDreenc is false.

Re-encoding of the current frame may be achieved by using a different frame rate, a different frame type, a different initial quantization parameter, and/or a different resolution. Further details of the proposed adaptive re-encoding scheme implemented in the video encoder 100/400 are described as below.

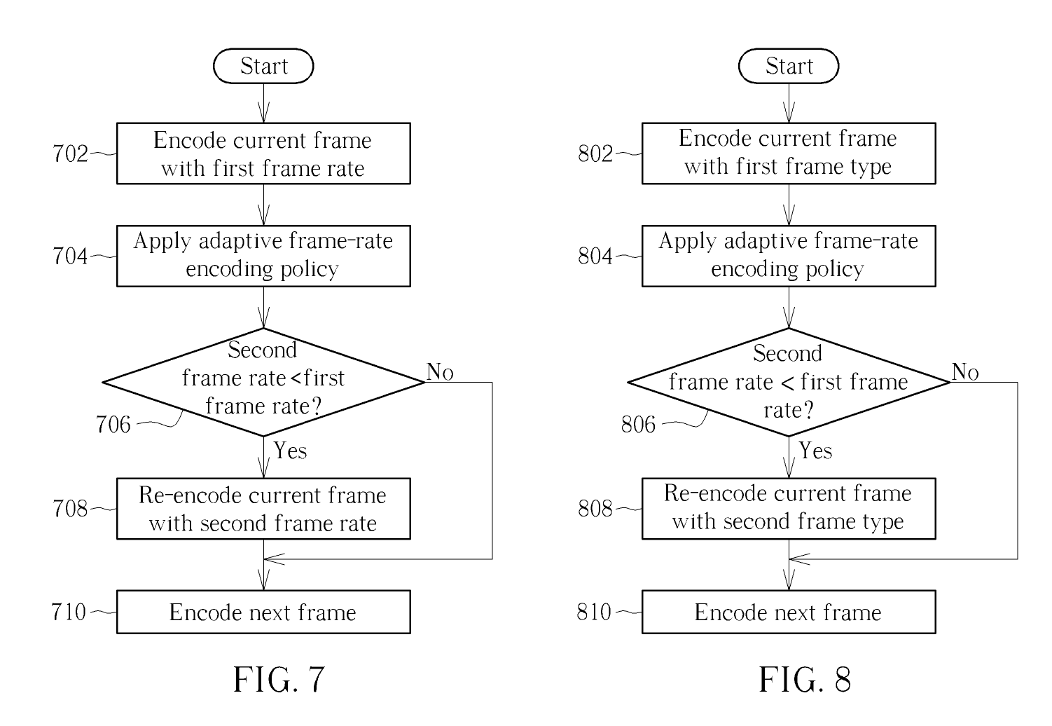

FIG. 7 is a flowchart illustrating a first adaptive re-encoding policy that depends on an adaptive frame-rate encoding policy according to an embodiment of the present invention. Provided that the result is substantially the same, the steps are not required to be executed in the exact order shown in FIG. 7. The flow shown in FIG. 7 may be performed by the video encoder 100/400. At step 702, the encoding circuit 103/402 encodes the current frame with a first frame rate to generate a current encoded frame. At step 704, the control circuit 104/404 applies the adaptive frame-rate encoding policy, and gets a second frame rate. The second frame rate may be indicated by the next drop-frame level LVdf that is determined by the adaptive frame-rate encoding policy of the video encoder 100, or may be indicated by the next frame-rate level LVfr that is determined by the adaptive frame-rate encoding policy of the video encoder 400. At step 706, the control circuit 104/404 checks if the second frame rate is lower than the first frame rate. When the second frame rate is not lower than the first frame rate, the control circuit 104/404 sets the re-encode indication INDreenc as false to disable re-encoding of the current frame, and the flow proceeds with step 710 for processing a next frame that is received by the encoding circuit 103/402 and becomes a current frame to be encoded by the encoding circuit 103/402. It should be noted that the same adaptive re-encoding policy may also be applied to the next frame for adaptively re-encoding the next frame with a different frame rate.

When the second frame rate is lower than the first frame rate, the control circuit 104/404 sets the re-encode indication INDreenc as true to enable re-encoding of the current frame. Hence, at step 708, the encoding circuit 103/402 re-encodes the current frame with the second frame rate that is different from (e.g., lower than) the first frame rate. Next, the flow proceeds with step 710 for processing a next frame that is received by the encoding circuit 103/402 and becomes a current frame to be encoded by the encoding circuit 103/402. It should be noted that the same adaptive re-encoding policy may also be applied to the next frame for adaptively re-encoding the next frame with a different frame rate.

FIG. 8 is a flowchart illustrating a second adaptive re-encoding policy that depends on an adaptive frame-rate encoding policy according to an embodiment of the present invention. Provided that the result is substantially the same, the steps are not required to be executed in the exact order shown in FIG. 8. The flow shown in FIG. 8 may be performed by the video encoder 100/400. At step 802, the encoding circuit 103/402 encodes the current frame with a first frame rate and a first frame type to generate a current encoded frame. At step 804, the control circuit 104/404 applies the adaptive frame-rate encoding policy, and gets a second frame rate. The second frame rate may be indicated by the next drop-frame level LVdf that is determined by the adaptive frame-rate encoding policy of the video encoder 100, or may be indicated by the next frame-rate level LVfr that is determined by the adaptive frame-rate encoding policy of the video encoder 400. At step 806, the control circuit 104/404 checks if the second frame rate is lower than the first frame rate. When the second frame rate is not lower than the first frame rate, the control circuit 104/404 sets the re-encode indication INDreenc as false to disable re-encoding of the current frame, and the flow proceeds with step 810 for processing a next frame that is received by the encoding circuit 103/402 and becomes a current frame to be encoded by the encoding circuit 103/402. It should be noted that the same adaptive re-encoding policy may also be applied to the next frame for adaptively re-encoding the next frame with a different frame type.

When the second frame rate is lower than the first frame rate, the control circuit 104/404 sets the re-encode indication INDreenc as true to enable re-encoding of the current frame. Hence, at step 808, the encoding circuit 103/402 re-encodes the current frame with the second frame rate and a second frame type, wherein the second frame rate is different from (e.g., lower than) the first frame rate, and the second frame type is different from the first frame type.

For example, the encoding-related information INFenc may further include mode type information of blocks that are encoded in the current encoded frame. One block in a frame may be encoded in an intra mode or an inter mode when a frame type of the frame is an inter frame. Each block in a frame is encoded in an intra mode when a frame type of the frame is an intra frame. The second frame type may be determined by the control circuit 404 according to the mode type information of blocks that are encoded in the current encoded frame. Suppose that the first frame type is an inter frame. Hence, the current frame with the first frame type may have all blocks encoded in the inter mode, or may have all blocks encoded in the intra mode, or may have some blocks encoded in the intra mode and some blocks encoded in the inter mode. Since one block may be encoded in the intra mode or the inter mode when the frame type is an inter frame, the mode type of each block that is encoded in the current encoded frame is required to be signaled. In other words, extra bits in the bitstream are needed to signal mode types of blocks that are encoded in the current encoded frame. If a ratio of blocks in the current frame that are encoded in intra mode to all blocks in the current frame is larger than a predetermined threshold, the coding efficiency of the current frame can be improved by re-encoding the current frame with the second frame type that is determined as an intra frame. Since the current frame with the second frame type may have all blocks encoded in the intra mode only, the number of extra bits in the bitstream that are used to signal mode types of blocks encoded in the current encoded frame can be significantly reduced. Hence, if the first frame type is an inter frame and a ratio of blocks in the current frame that are encoded in intra mode to all blocks in the current frame is larger than a predetermined threshold, the second frame type may be determined as an intra frame.

After the current frame is re-encoded at step 808, the flow proceeds with step 810 for processing a next frame that is received by the encoding circuit 103/402 and becomes a current frame to be encoded by the encoding circuit 103/402. It should be noted that the same adaptive re-encoding policy may also be applied to the next frame for adaptively re-encoding the next frame with a different frame type.

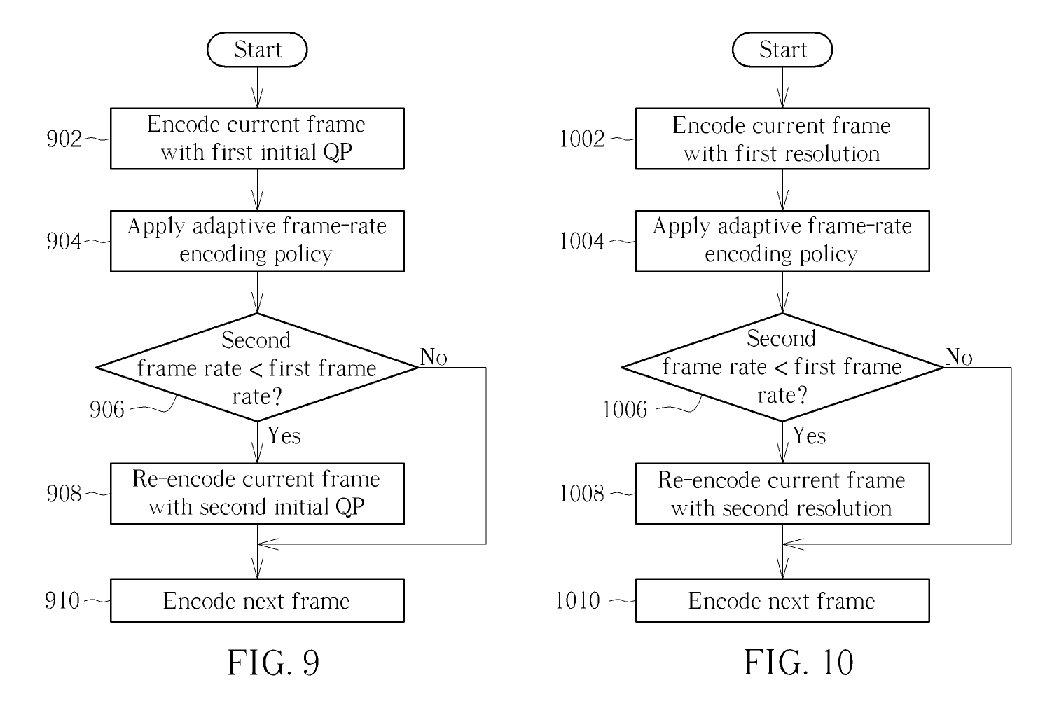

FIG. 9 is a flowchart illustrating a third adaptive re-encoding policy that depends on an adaptive frame-rate encoding policy according to an embodiment of the present invention. Provided that the result is substantially the same, the steps are not required to be executed in the exact order shown in FIG. 9. The flow shown in FIG. 9 may be performed by the video encoder 100/400. At step 902, the encoding circuit 103/402 encodes the current frame with a first frame rate and a first initial quantization parameter to generate a current encoded frame, wherein an initial quantization parameter is applied to encoding of the first block in the current frame (e.g., a left-most block in a top-most block row of the current frame). At step 904, the control circuit 104/404 applies the adaptive frame-rate encoding policy, and gets a second frame rate. The second frame rate may be indicated by the next drop-frame level LVdf that is determined by the adaptive frame-rate encoding policy of the video encoder 100, or may be indicated by the next frame-rate level LVfr that is determined by the adaptive frame-rate encoding policy of the video encoder 400. At step 906, the control circuit 104/404 checks if the second frame rate is lower than the first frame rate. When the second frame rate is not lower than the first frame rate, the control circuit 104/404 sets the re-encode indication INDreenc as false to disable re-encoding of the current frame, and the flow proceeds with step 910 for processing a next frame that is received by the encoding circuit 103/402 and becomes a current frame to be encoded by the encoding circuit 103/402. It should be noted that the same adaptive re-encoding policy may also be applied to the next frame for adaptively re-encoding the next frame with a different initial quantization parameter.

When the second frame rate is lower than the first frame rate, the control circuit 104/404 sets the re-encode indication INDreenc as true to enable re-encoding of the current frame. Hence, at step 908, the encoding circuit 103/402 re-encodes the current frame with the second frame rate and a second initial quantization parameter, wherein the second frame rate is different from (e.g., lower than) the first frame rate, and the second initial quantization parameter is different from the first initial quantization parameter. As mentioned above, the encoding-related information INFenc may include quantization parameters assigned to blocks that are encoded in the current encoded frame. If the first initial quantization parameter is not properly set (e.g., the first initial quantization parameter is set by a small value), it is possible that the quantization parameters assigned to blocks change frequently. The coding efficiency of the current frame may be poor due to more bits needed to record different quantization parameter settings. The coding efficiency of the current frame can be improved by re-encoding the current frame with the second frame type that is determined according to the quantization parameters assigned to blocks that are encoded in the current encoded frame. In this embodiment, the control circuit 104 determines the second initial quantization parameter by applying an arithmetic operation to quantization parameters assigned to blocks that are encoded in the current encoded frame. For example, the second initial quantization parameter is the average of quantization parameters assigned to blocks that are encoded in the current encoded frame. For another example, the second initial quantization parameter is the maximum value among quantization parameters assigned to blocks that are encoded in the current encoded frame. For yet another example, the second initial quantization parameter is the median value among quantization parameters assigned to blocks that are encoded in the current encoded frame.

After the current frame is re-encoded at step 908, the flow proceeds with step 910 for processing a next frame that is received by the encoding circuit 103/402 and becomes a current frame to be encoded by the encoding circuit 103/402. It should be noted that the same adaptive re-encoding policy may also be applied to the next frame for adaptively re-encoding the next frame with a different initial quantization parameter.

FIG. 10 is a flowchart illustrating a fourth adaptive re-encoding policy that depends on an adaptive frame-rate encoding policy according to an embodiment of the present invention. Provided that the result is substantially the same, the steps are not required to be executed in the exact order shown in FIG. 10. The flow shown in FIG. 10 may be performed by the video encoder 100/400. At step 1002, the encoding circuit 103/402 encodes the current frame with a first frame rate and a first resolution to generate a current encoded frame. At step 1004, the control circuit 104/404 applies the adaptive frame-rate encoding policy, and gets a second frame rate. The second frame rate may be indicated by the next drop-frame level LVdf that is determined by the adaptive frame-rate encoding policy of the video encoder 100, or may be indicated by the next frame-rate level LVfr that is determined by the adaptive frame-rate encoding policy of the video encoder 400. At step 1006, the control circuit 104/404 checks if the second frame rate is lower than the first frame rate. When the second frame rate is not lower than the first frame rate, the control circuit 104/404 sets the re-encode indication INDreenc as false to disable re-encoding of the current frame, and the flow proceeds with step 1010 for processing a next frame that is received by the encoding circuit 103/402 and becomes a current frame to be encoded by the encoding circuit 103/402. It should be noted that the same adaptive re-encoding policy may also be applied to the next frame for adaptively re-encoding the next frame with a different resolution.

When the second frame rate is lower than the first frame rate, the control circuit 104/404 sets the re-encode indication INDreenc as true to enable re-encoding of the current frame. Hence, at step 1008, the encoding circuit 103/402 re-encodes the current frame with the second frame rate and a second resolution, wherein the second frame rate is different from (e.g., lower than) the first frame rate, and the second resolution is different from (e.g., smaller than) the first resolution.

The encoding-related information INFenc may further include bit-budget information of the current frame. If the first resolution is high, it is possible that the bit budget after encoding the current frame with the first resolution is lower than a predetermined threshold. That is, the difference between a bit budget assigned to the current frame and the number of bits of the current encoded frame may be lower than the predetermined threshold. The number of bits of the current encoded frame can be reduced by re-encoding the current frame with the second resolution that is determined according to the bit-budget information of the current frame. For example, if the bit budget after encoding the current frame with the first resolution is lower than the predetermined threshold, the control circuit 104/404 sets the second resolution by a value smaller than the first resolution.

After the current frame is re-encoded at step 1008, the flow proceeds with step 1010 for processing a next frame that is received by the encoding circuit 103/402 and becomes a current frame to be encoded by the encoding circuit 103/402. It should be noted that the same adaptive re-encoding policy may also be applied to the next frame for adaptively re-encoding the next frame with a different resolution.

In some embodiments of the present invention, the video encoder 100/400 may employ the proposed adaptive frame-rate encoding policy without using the proposed adaptive re-encoding policy. Taking the video encoder 100 for example, the control circuit 104 may adaptively adjust the drop-frame level LVdf without adaptively setting the re-encode indication INDreenc. Taking the video encoder 400 for example, the control circuit 404 may adaptively adjust the frame-rate level LVfr without adaptively setting the re-encode indication INDreenc.

In some embodiments of the present invention, the video encoder 100/400 may employ the proposed adaptive frame-rate encoding policy as well as the proposed adaptive re-encoding policy. Taking the video encoder 100 for example, the control circuit 104 may adaptively adjust the drop-frame level LVdf, and may also adaptively set the re-encode indication INDreenc. Taking the video encoder 400 for example, the control circuit 404 may adaptively adjust the frame-rate level LVfr, and may also adaptively set the re-encode indication INDreenc. Note that a frame rate determined by the adaptive frame-rate encoding policy is involved in controlling the adaptive re-encoding policy. However, this is for illustrative purposes only, and is not meant to be a limitation of the present invention. In an alternative design, the adaptive re-encoding may be controlled by re-encode indication INDreenc that is not set according to a comparison of a first frame rate and a second frame.

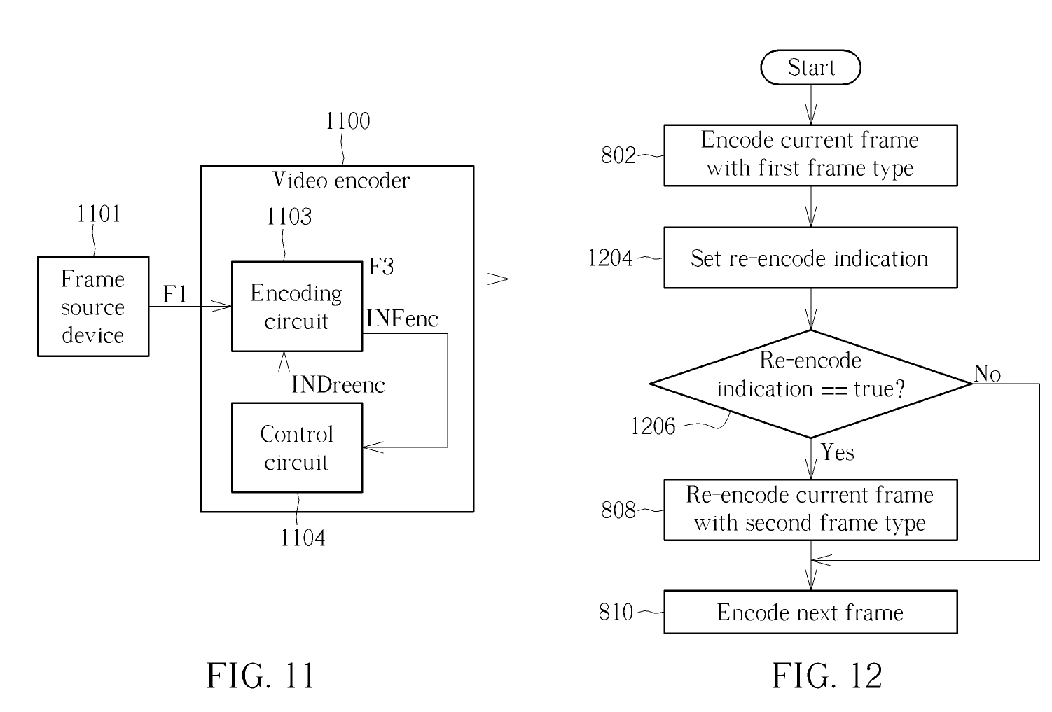

FIG. 11 is a diagram illustrating a third video encoder for adaptive video encoding according to an embodiment of the present invention. In some embodiments of the present invention, the video encoder 1100 may be a part of a wireless communication apparatus such as a tablet or a mobile phone. The video encoder 1100 is coupled to the frame source device 1101. For example, the frame source device 1101 may be an image capture device (e.g., an image sensor of a camera module) also located at the wireless communication apparatus. In this embodiment, the video encoder 1100 supports adaptive video encoding, and includes an encoding circuit 1103 and a control circuit 1104. The frame source device 1101 is arranged to generate and output successive frames (i.e., un-encoded frames) F1 to the encoding circuit 1103. The encoding circuit 1103 is arranged to encode the frames F1 to generate and output corresponding encoded frames F3, respectively.

The control circuit 1104 is implemented to control an adaptive re-encoding function of the video encoder 1100. In this embodiment, after the current frame is encoded to generate the current encoded frame, the control circuit 1104 gets encoding-related information INFenc of the current frame encoded by the encoding circuit 1103, and sets the re-encode indication INDreenc according to at least the encoding-related information INFenc. The encoding circuit 1103 refers to the re-encode indication INDreenc for adaptively re-encoding the current frame to update the current encoded frame that will be transmitted via communication channel(s). Hence, when the control circuit 1104 sets the re-encode indication INDreenc as true, re-encoding of the current frame is enabled at the encoding circuit 1103; and when the control circuit 1104 sets the re-encode indication INDreenc as false, re-encoding of the current frame is disabled at the encoding circuit 1103.

Re-encoding of the current frame may be achieved by using a different frame type, a different initial quantization parameter, and/or a different resolution. Further details of the proposed adaptive re-encoding scheme implemented in the video encoder 1100 are described as below.

FIG. 12 is a flowchart illustrating a first adaptive re-encoding policy that is independent of an adaptive frame-rate encoding policy according to an embodiment of the present invention. Provided that the result is substantially the same, the steps are not required to be executed in the exact order shown in FIG. 12. The flow shown in FIG. 12 may be performed by the video encoder 1100. The major difference between flows shown in FIG. 8 and FIG. 12 is that step 804 is replaced with step 1204, and step 806 is replaced with step 1206. At step 1204, the control circuit 1104 sets the re-encode indication INDreenc according to the encoding-related information INFenc of the current frame encoded by the encoding circuit 1103.

For example, the encoding-related information INFenc may include mode type information of blocks that are encoded in the current encoded frame. One block of a frame may be encoded in an intra mode or an inter mode when a frame type of the frame is an inter frame. Each block of a frame is encoded in an intra mode when a frame type of the frame is an intra frame. A second frame type maybe determined by the control circuit 1104 according to the mode type information of blocks that are encoded in the current encoded frame. In a first exemplary design, the controller 1104 sets the re-encode indication INDreenc as true when the second frame type determined for re-encoding the current frame is different from the first frame type; otherwise, the control circuit 1104 sets the re-encode indication INDreenc as false.

Suppose that the first frame type is an inter frame. Hence, the current frame with the first frame type may have all blocks encoded in the inter mode, or may have all blocks encoded in the intra mode, or may have some blocks encoded in the intra mode and some blocks encoded in the inter mode. Since one block may be encoded in the intra mode or the inter mode when the frame type is an inter frame, the mode type of each block that is encoded in the current encoded frame is required to be signaled. In other words, extra bits in the bitstream are needed to signal mode types of blocks that are encoded in the current encoded frame. If a ratio of blocks in the current frame that are encoded in intra mode to all blocks in the current frame is larger than a predetermined threshold, the coding efficiency of the current frame can be improved by re-encoding the current frame with the second frame type that is determined as an intra frame. Since the current frame with the second frame type may have all blocks encoded in the intra mode only, the number of extra bits in the bitstream that are used to signal mode types of blocks encoded in the current encoded frame can be significantly reduced. In a second exemplary design, the controller 1104 sets the re-encode indication INDreenc as true if the first frame type is an inter frame and a ratio of blocks in the current frame that are encoded in intra mode to all blocks in the current frame is larger than a predetermined threshold; otherwise, the controller 1104 sets the re-encode indication INDreenc as false.

At step 1206, the encoding circuit 1103 checks if the re-encode indication INDreenc is true. When the re-encode indication INDreenc is false, re-encoding of the current frame is disabled, and the flow proceeds with step 810 for processing a next frame that is received by the encoding circuit 1103 and becomes a current frame to be encoded by the encoding circuit 1103. As mentioned above, the same adaptive re-encoding policy may also be applied to the next frame for adaptively re-encoding the next frame with a different frame type. When the re-encode indication INDreenc is true, re-encoding of the current frame is enabled. Hence, at step 808, the encoding circuit 1103 re-encodes the current frame with the second frame type, wherein the second frame type is different from the first frame type. For example, if the first frame type is an inter frame and a ratio of blocks in the current frame that are encoded in intra mode to all blocks in the current frame is larger than a predetermined threshold, the second frame type is determined as an intra frame.

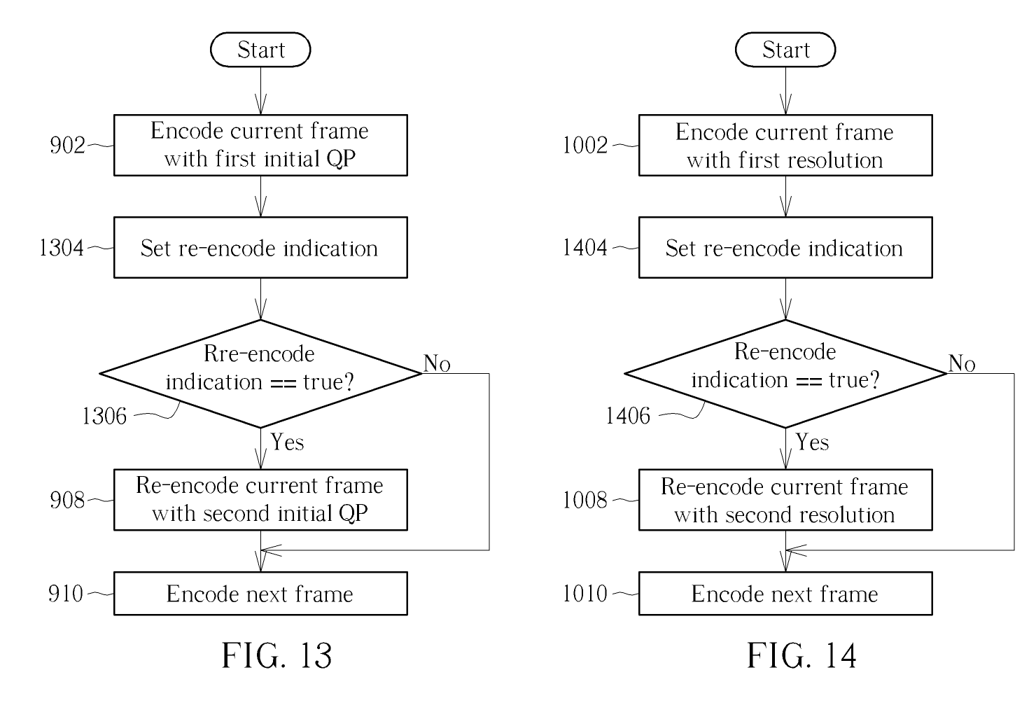

FIG. 13 is a flowchart illustrating a second adaptive re-encoding policy that is independent of an adaptive frame-rate encoding policy according to an embodiment of the present invention. Provided that the result is substantially the same, the steps are not required to be executed in the exact order shown in FIG. 13. The flow shown in FIG. 13 may be performed by the video encoder 1100. The major difference between flows shown in FIG. 9 and FIG. 13 is that step 904 is replaced with step 1304, and step 906 is replaced with step 1306. At step 1304, the control circuit 1104 sets the re-encode indication INDreenc according to the encoding-related information INFenc of the current frame encoded by the encoding circuit 1103.

For example, the encoding-related information INFenc may include quantization parameters assigned to blocks that are encoded in the current encoded frame. In a first exemplary design, the control circuit 1104 sets the re-encode indication INDreenc as true when a quantization parameter calculation result is larger than a first predetermined threshold; otherwise, the control circuit 1104 sets the re-encode indication INDreenc as false. The quantization parameter calculation result may be derived from applying an arithmetic operation to quantization parameters assigned to blocks that are encoded in the current encoded frame. For example, the quantization parameter calculation result can be the absolute difference of the maximum value and the minimum value among the quantization parameters assigned to blocks that are encoded in the current encoded frame. For another example, the quantization parameter calculation result can be the variance of the quantization parameters assigned to blocks that are encoded in the current encoded frame. For yet another example, the quantization parameter calculation result can be the average value of the quantization parameters assigned to blocks that are encoded in the current encoded frame. For further another example, the quantization parameter calculation result can be the maximum value (or the minimum value) of the quantization parameters assigned to blocks that are encoded in the current encoded frame.

If the first initial quantization parameter is not properly set (e.g., the first initial quantization parameter is set by a small value), it is possible that the quantization parameters assigned to blocks change frequently. The coding efficiency of the current frame may be poor due to more bits needed to record the different quantization parameter settings. The coding efficiency of the current frame can be improved by re-encoding the current frame with the second frame type that is determined according to the quantization parameters assigned to blocks that are encoded in the current encoded frame. In a second exemplary design, the controller 1104 sets the re-encode indication INDreenc as true when a difference between the first initial quantization parameter and the second initial quantization parameter determined for re-encoding the current frame is larger than a second predetermined threshold; otherwise, the control circuit 1104 sets the re-encode indication INDreenc as false.

At step 1306, the encoding circuit 1103 checks if the re-encode indication INDreenc is true. When the re-encode indication INDreenc is false, re-encoding of the current frame is disabled, and the flow proceeds with step 910 for processing a next frame that is received by the encoding circuit 1103 and becomes a current frame to be encoded by the encoding circuit 1103. As mentioned above, the same adaptive re-encoding policy may also be applied to the next frame for adaptively re-encoding the next frame with a different initial quantization parameter. When the re-encode indication INDreenc is true, re-encoding of the current frame is enabled. Hence, at step 908, the encoding circuit 1103 re-encodes the current frame with the second initial quantization parameter, wherein the second initial quantization parameter is different from the first initial quantization parameter. The control circuit 104 may determine the second initial quantization parameter by applying an arithmetic operation to quantization parameters assigned to blocks that are encoded in the current encoded frame. For example, the second initial quantization parameter is the average of quantization parameters assigned to blocks that are encoded in the current encoded frame. For another example, the second initial quantization parameter is the maximum value among quantization parameters assigned to blocks that are encoded in the current encoded frame. For yet another example, the second initial quantization parameter is the median value among quantization parameters assigned to blocks that are encoded in the current encoded frame.

FIG. 14 is a flowchart illustrating a third adaptive re-encoding policy that is independent of an adaptive frame-rate encoding policy according to an embodiment of the present invention. Provided that the result is substantially the same, the steps are not required to be executed in the exact order shown in FIG. 14. The flow shown in FIG. 14 may be performed by the video encoder 1100. The major difference between the flows shown in FIG. 10 and FIG. 14 is that step 1004 is replaced with step 1404, and step 1006 is replaced with step 1406. At step 1404, the control circuit 1104 sets the re-encode indication INDreenc according to the encoding-related information INFenc of the current frame encoded by the encoding circuit 1103.

For example, the encoding-related information INFenc may include bit-budget information of the current frame. If the first resolution is high, it is possible that the bit budget after encoding the current frame with the first resolution is lower than a predetermined threshold. That is, the difference between a bit budget assigned to the current frame and the number of bits of the current encoded frame may be lower than the predetermined threshold. The number of bits of the current encoded frame can be reduced by re-encoding the current frame with the second resolution that is determined according to the bit-budget information of the current frame. In a first exemplary design, the controller 1104 sets the re-encode indication INDreenc as true when a ratio of the first resolution to the second resolution determined for re-encoding the current frame is larger than a first predetermined threshold; otherwise, the control circuit 1104 sets the re-encode indication INDreenc as false. The first resolution is defined by an image width W1 and an image height H1. The second resolution is defined by an image width W2 and an image height H2, where W2≠W1 and/or H2≠H1. The ratio of the first resolution to the second resolution may be expressed as W1*H1/W2*H2.

In a second exemplary design, the controller 1104 sets the re-encode indication INDreenc as true when the bit budget after encoding the current frame with the first resolution is lower than a second predetermined threshold; otherwise, the control circuit 1104 sets the re-encode indication INDreenc as false.

At step 1406, the control circuit 1104 checks if the re-encode indication INDreenc is true. When the re-encode indication INDreenc is false, re-encoding of the current frame is disabled, and the flow proceeds with step 1010 for processing a next frame that is received by the encoding circuit 1103 and becomes a current frame to be encoded by the encoding circuit 1103. As mentioned above, the same adaptive re-encoding policy may also be applied to the next frame for adaptively re-encoding the next frame with a different resolution. When the re-encode indication INDreenc is true, re-encoding of the current frame is enabled. Hence, at step 1008, the encoding circuit 1103 re-encodes the current frame with the second resolution, wherein the second resolution is different from (e.g., smaller than) the first resolution. For example, if the bit budget after encoding the current frame with the first resolution is lower than the second predetermined threshold, the control circuit 1104 sets the second resolution by a value smaller than the first resolution.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An adaptive video encoding method comprising:
encoding, by an encoding circuit, a current frame to generate a current encoded frame; and
after the current frame is encoded:
obtaining quantization parameter information of at least one encoded frame, wherein said at least one encoded frame comprises the current encoded frame; and
referring to the quantization parameter information to adaptively adjust a frame rate of at least one next frame to be actually encoded by the encoding circuit.

2. The adaptive video encoding method of claim 1, wherein referring to the quantization parameter information to adaptively adjust the frame rate of said at least one next frame comprises:
determining a next drop-frame level according to a current drop-frame level and the quantization parameter information; and
adaptively adjusting the frame rate of said at least one next frame by selectively dropping at least one frame received from a frame source device according to the next drop-frame level.

3. The adaptive video encoding method of claim 1, wherein referring to the quantization parameter information to adaptively adjust the frame rate of said at least one next frame comprises:
determining a next frame-rate level according to a current frame-rate level and the quantization parameter information; and
adaptively adjusting the frame rate of said at least one next frame by instructing a frame source device to provide at least one frame at a frame rate that is designated by the next frame-rate level.

4. The adaptive video encoding method of claim 1, wherein obtaining the quantization parameter information of said at least one encoded frame comprises:
determining the quantization parameter information by applying an arithmetic operation to quantization parameters derived from quantization parameters assigned to blocks that are encoded in said at least one encoded frame.

5. The adaptive video encoding method of claim 1, wherein the current frame with a first frame rate is encoded to generate the current encoded frame, and the adaptive video encoding method further comprises:
after the current frame with the first frame rate is encoded:
checking if the frame rate of said at least one next frame is lower than the first frame rate of the current frame; and
when the frame rate of said at least one next frame is lower than the first frame rate of the current frame, re-encoding the current frame to update the current encoded frame.

6. The adaptive video encoding method of claim 5, wherein re-encoding the current frame comprises:
re-encoding the current frame with a second frame rate, wherein the second frame rate is different from the first frame rate.

7. The adaptive video encoding method of claim 6, wherein the second frame rate is set by the frame rate of said at least one next frame that is adaptively adjusted according to the quantization parameter information.

8. The adaptive video encoding method of claim 5, wherein the current frame with a first frame type and the first frame rate is encoded to generate the current encoded frame, and re-encoding the current frame comprises:
re-encoding the current frame with a second frame type, wherein the second frame type is different from the first frame type.

9. The adaptive video encoding method of claim 8, wherein the first frame type is an inter frame, and the second frame type is an intra frame.

10. The adaptive video encoding method of claim 5, wherein the current frame with a first initial quantization parameter and the first frame rate is encoded to generate the current encoded frame, and re-encoding the current frame comprises:
re-encoding the current frame with a second initial quantization parameter, wherein the second initial quantization parameter is different from the first initial quantization parameter.

11. The adaptive video encoding method of claim 10, wherein re-encoding the current frame further comprises:
determining the second initial quantization parameter by applying an arithmetic operation to quantization parameters assigned to blocks that are encoded in the current encoded frame.

12. The adaptive video encoding method of claim 5, wherein the current frame with a first resolution and the first frame rate is encoded to generate the current encoded frame, and re-encoding the current frame comprises:
re-encoding the current frame with a second resolution, wherein the second resolution is different from the first resolution.

13. The adaptive video encoding method of claim 12, wherein the second resolution is smaller than the first resolution.

14. An adaptive video encoding method comprising:
encoding, by an encoding circuit, a current frame to generate a current encoded frame; and
after the current frame is encoded:
setting re-encode indication according to at least encoding-related information of the current frame; and
referring to the re-encode indication for adaptively re-encoding, by the encoding circuit, the current frame to update the current encoded frame.

15. The adaptive video encoding method of claim 14, wherein the current frame with a first frame type is encoded to generate the current encoded frame, and re-encoding the current frame comprises:
re-encoding the current frame with a second frame type, wherein the second frame type is different from the first frame type.

16. The adaptive video encoding method of claim 15, wherein setting the re-encode indication according to at least the encoding-related information of the current frame comprises:
setting the re-encode indication as true when the second frame type determined for re-encoding the current frame is different from the first frame type; or
setting the re-encode indication as true when a ratio of blocks in the current frame that are encoded in an intra mode to all blocks in the current frame is larger than a predetermined threshold.

17. The adaptive video encoding method of claim 14, wherein the current frame with a first initial quantization parameter is encoded to generate the current encoded frame, and re-encoding the current frame comprises:
re-encoding the current frame with a second initial quantization parameter, wherein the second initial quantization parameter is different from the first initial quantization parameter.

18. The adaptive video encoding method of claim 17, wherein setting the re-encode indication according to at least the encoding-related information of the current frame comprises:
setting the re-encode indication as true when a quantization parameter calculation result is larger than a first predetermined threshold, wherein the quantization parameter calculation result is derived from applying an arithmetic operation to quantization parameters assigned to blocks that are encoded in the current encoded frame; or
setting the re-encode indication as true when a difference between the first initial quantization parameter and the second initial quantization parameter determined for re-encoding the current frame is larger than a second predetermined threshold.

19. The adaptive video encoding method of claim 14, wherein the current frame with a first resolution is encoded to generate the current encoded frame, and re-encoding the current frame comprises:
re-encoding the current frame with a second resolution, wherein the second resolution is different from the first resolution.

20. The adaptive video encoding method of claim 19, wherein setting the re-encode indication according to at least the encoding-related information of the current frame comprises:
setting the re-encode indication as true when a ratio of the first resolution to the second resolution determined for re-encoding the current frame is larger than a first predetermined threshold; or
setting the re-encode indication as true when a bit budget after encoding the current frame with the first resolution is lower than a second predetermined threshold.

21. A video encoder for adaptive video encoding, comprising:
an encoding circuit, arranged to encode a current frame to generate a current encoded frame; and
a control circuit, wherein after the current frame is encoded, the control circuit is arranged to:
obtain quantization parameter information of at least one encoded frame, wherein said at least one encoded frame comprises the current encoded frame; and
refer to the quantization parameter information to adaptively adjust a frame rate of at least one next frame to be actually encoded by the encoding circuit.

22. A video encoder for adaptive video encoding, comprising:
an encoding circuit, arranged to encode a current frame to generate a current encoded frame; and
a control circuit;
wherein after the current frame is encoded, the control circuit is arranged to set re-encode indication according to at least encoding-related information of the current frame, and the encoding circuit is further arranged to refer to the re-encode indication for adaptively re-encoding the current frame to update the current encoded frame.
